(19) United States
(12) Patent Application Publication
(10) Pub. No.: US 2011/0213974 A1
(43) Pub. Date: Sep. 1, 2011

(54) IDENTIFYING RELATIONSHIPS BETWEEN USERS OF A COMMUNICATIONS DOMAIN

(75) Inventors: Sebastien Ardon, New South Wales (AU); Aruna Seneviratne, New South Wales (AU); Ott Maximilian, New South Wales (AU)

(73) Assignee: NATIONAL ICT AUSTRALIA LIMITED, Eveleigh (AU)

(21) Appl. No.: 12/667,842

(22) PCT Filed: Sep. 10, 2009
(86) PCT No.: PCT/AU2009/001186

§ 371 Date: Jan. 5, 2010

(30) Foreign Application Priority Data
Sep. 10, 2008 (AU) 2008904718

(51) Int. Cl. H04L 9/32

(52) U.S. Cl. 713/169

(57) ABSTRACT

The invention enables identifying relationships between users of a online communications domain such as a social networking website. First identification tokens 20, 34 and 36 are stored that are each encrypted identification information associated with a domain user A, B and C. Then the service provider 58 receives relationship tokens 72 from a first user A, wherein each relationship token 72 is one-way encrypted identification information associated with a possible domain user B and C. The service provider 58 compares the relationship tokens 72 to the identification tokens to identify any matches. For each match to a unique domain user B and C, identifying a relationship between the first user and the domain user B and C associated with the matched identification token. This relationship allows communication in the domain between the first user A and the domain user B and C. It is an advantage of the invention that the relationships between users can be identified while preserving their privacy. By receiving only encrypted identity information the underlying identity information is unintelligible to the communications domain.

### TECHNICAL FIELD

The invention concerns identifying relationships between users of a communication domains. For example, but not limited to, identifying relationships between users of a online communications domain such as a social networking website. Aspects of the invention include methods, computer systems and software.

### BACKGROUND ART

Communication domains are typically comprised of multiple online communication enabled devices that each are equipped with software to send and receive communications in that domain. Example devices are computers, portable computers, mobile phones and personal digital assistant devices.

Communication domains are currently used by millions of people (i.e. users) worldwide to interact on a daily basis. Example domains are online social networks, virtual worlds and instant messaging systems.

Users of these domains have relationships with others users. These relationships define how the two related users can communicate in the domain. A relationship between two users must be identified before the users can communicate in that domain. A relationship may be a one-to-one or a one-to-many relationship. An example of a one-to-one relationship is between two users. An example of a one-to-many relationship is between a user and another user that represents a set of users. The set may be closed, such as set of specific users defined in that user's buddy list. Alternatively, the set may be open, such as all users residing in Australia.

A central service provider typically supports services associated with the online communications domain. The service provider, such as a constellation of central server, stores information relating to each user, such as their identity information and information on their identified relationship.

In most existing online communication domains, the relationship between users are explicitly defined by users themselves, and usually include a request and an authorisation step. The process for a new user is described as follows:
(a) The new user first registers with the online communications domain. To do this the new user provides identity information to the service provider of the communications domain, such as their name and email address.
(b) Next the new user performs searches on the information identity stored by the service provider to identify other users already registered with the communications domain that they wish to create a relationship with. Searching involves providing to the service provider information about these other users in a provided interface. This may be done manually, with the first user entering identification information into a search interface one at a time. Alternatively, it can be automated in part by the first user allowing the communications domain access to their address book. For example, the first user provides the communications domain with their password to their email account hosted by a third party which includes their address book. The server of the communications domain accesses and makes a copy of the address book and automatically attempts to match identification information in the address book with registered users. The interface then displays an indication on whether matches were found to the first user.
(c) For each match that the new user thinks is correct, the new user requests to form a relationship with them. This usually involves the service provider sending to the matched user a message asking whether they authorise the relationship between them and the new user.
(d) For each accepted authorisation message, a relationship is formed between them and the new user.

The new user may also have new relationships identified as other users perform searches on the new user's identification information.

In some domains the authorisation is automatic with no authorisation check required.

Once the new user has a relationship with another user, the new user can use the communications domain to communicate with that user.

### SUMMARY OF INVENTION

In a first aspect the invention provides a computer implemented method of identifying relationships between users in a communications domain comprising:
(a) storing identification tokens, wherein each identification token is one-way encrypted identification information associated with a domain user;
(b) receiving relationship tokens from a first user, wherein each relationship token is one-way encrypted identification information associated with a possible domain user;
(c) comparing the relationship tokens to the identification tokens to identify any matches; and
(d) for each match to a unique domain user, identifying a relationship between the first user and the domain user associated with the matched identification token, wherein the relationship allows communication in the domain between the first user and the domain user associated with the matched identification token.

It is an advantage of the invention that the relationships between users can be identified while preserving the privacy of each of the users, both of their actual identity and the identity of each user they have a relationship with. By receiving only one-way encrypted identity information the underlying identity information is unintelligible to the communications domain. This helps to prevent the use of this information in an unauthorized manner by the service provider of the communications domain and reduces the negative impacts of potential unauthorized access of the information.

At the same time the identified relationships can be used to help identity further relationships or help ensure further identified relationships are correct while still maintaining the privacy of the users.

The one-way encrypted identification information of an identification token may correspond to one or more identity attributes of the associated domain user.

The one-way encrypted identification information of a relationship token may correspond to one or more identity attributes of a possible domain user.

An identity attribute may be one of:
telephone number, (i.e. home, mobile, office)
email address,
facsimile number,
street address, and
user name in a different communications domain.

An identity attribute may be a predetermined number of suffix characters of an identity attribute. It is an advantage of this embodiment of the invention that matches can be identified despite variations in the notation of identity attributes that typically vary in the prefix of an identity attribute.

The identification information associated with possible domain users may be identification information known to the first user.

The one-way encrypted information is coded in a way that renders it unintelligible to the recipient. In this case, the communications domain is unable to decipher the underlying identification information as the tokens cannot be inverted. The encrypted identification information may be computed using a cryptographic secure hash. Examples includes SHA-1 or MD5.

The method may have an additional step of authorising the relationship with the domain user associated with the matched identification token.

The method may further comprises the step of analysing previously identified relationships of the first user and/or the domain user associated with the matched identification token and only identifying a match in step (c) if the previously identified relationships are indicative that the two users know each other.

The method may further comprise the step of only identifying a match in step (c) if at least two identification tokens associated with the domain user are matched to the relationship tokens of the first user.

The allowed communications between the first user and the domain user associated with the matched identification token in the communications domain may include one or more of:
online presence awareness communications,
access to content stored in the communications domain by the first user,
content transfers, e.g. emails, video files, and
real-time message interaction, e.g. voice and video calls, text based chat sessions.

In a second aspect the invention provides software, being computer readable instructions stored on computer readable media that when executed by a computer causes the computer to perform the method according to the method described immediately above.

In a third aspect the invention provides a computer system for identifying relationships between users in a communications domain comprising:
a storage device to store identification tokens, wherein each identification token is one-way encrypted identification information associated with a domain user;
an input means to receive relationship tokens from a first user, wherein each relationship token is one-way encrypted identification information associated with a possible domain user; and
a processor to compare the relationship tokens to the identification tokens to identify any matches, and, for each match to a unique domain user, identify a relationship between the first user and the domain user associated with the matched identification token, wherein the relationship allows communication in the domain between the first user and the domain user associated with the matched identification token and to store the identified relationship in the storage device.

The computer system may be a server or a collection of servers that offer services that support the communications domain.

In a fourth aspect the invention provides a computer implemented method for identifying relationships between a first user and other users in a communications domain, comprising:
(a) computing a set of relationship tokens, wherein each token in the set is one-way encrypted identification information of a possible user of the domain known to the first user;
(b) sending the set of relationship tokens to a service provider of the domain; and
(c) receiving an indication that relationships have been identified between the first user and a subset of the possible users, where the subset of possible users are registered users of the domain and the relationships allow communication in the domain between the first user and the subset of possible users.

The one-way encrypted identification information of a relationship token may corresponds to one or more identity attributes of a possible domain user. The identity attributes may be read from an electronic address book of the first user.

The method may further comprise the steps of:
computing identity tokens of the first user, wherein each identification token is one-way encrypted identification information associated with the first user;
sending the identity tokens to the service provider of the domain; and
receiving an indication that a relationship has been between identified between the first user and other domain users based on the identity tokens, wherein the identified relationship allows communication in the domain between the first user and the other domain users.

In a fifth aspect the invention provides software, being computer readable instructions stored on computer readable media that when executed by a computer causes the computer the perform the method described immediately above.

In a sixth aspect the invention provides a communications enabled device to identify relationships between a first user and other users in a communications domain, comprising:
processing means to computing a set of relationship tokens, wherein each token in the set is encrypted identification information of a possible user of the domain known to the first user;
output means to send the set of relationship tokens to a service provider of the domain; and
input means to receive an indication that relationships have been identified between the first user and a subset of the possible users, where the subset of possible users are registered users of the domain and the relationships allow communication in the domain between the first user and the subset of possible users.

### BRIEF DESCRIPTION OF THE DRAWINGS

An example of the invention will now be described with reference to the following drawings in which:

FIG. 1 is a schematic representation of users of a communications domain, and each user's identity and relationship information;

FIG. 2 is a schematic representation of users in the communications domain and the identified relationships in this example;

FIG. 2 is an example flowchart of the method performed to identify relationships in this communications domain;

FIG. 4 is a graph of the relationships between users of the communications domain in this example and

FIG. 5 is an example relation object model of tokens stored by the communications domain.

### BEST MODES OF THE INVENTION

An example of identifying relationships between users of a communications domain will now be described. In this example the communications domain is an online social network.

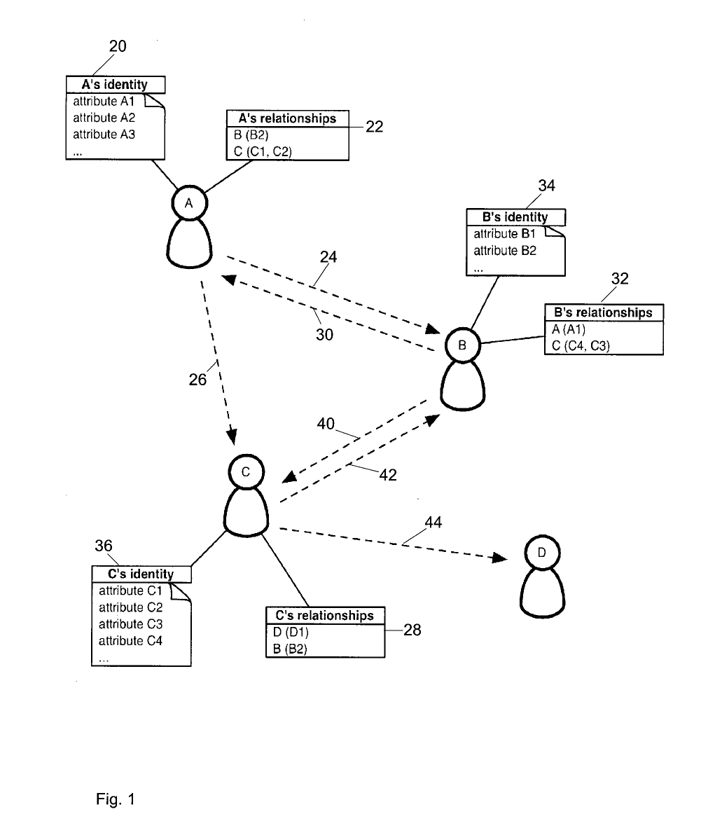

Referring to FIG. 1, there are four users shown, users A, B, C and D. Each user is associated with/uses one or more devices to communicate on the domain. In this example each user operates a personal computer or mobile internet-enabled device such as smartphone (not shown). Each device has the following:
an indication means, such as a display screen, that is able to display the graphical user interfaces to the social online network;
input means, such as a keyboard;
storage means, such as internal RAM or flash RAM, that stores both identity information of the user and identity information of users previously known to them. In this example the identity information is located in an contact list/address book that may form part of a phone or email application and is also stored on the computer;
connection means, such as an internet connection, so that the computer can communicate with the domain's service provider, such as a server (not shown) that is also connected to the internet; and
a processor and software to cause the computer to operate in accordance with the example described here. The software may be a client application, such as mobile client application, or web-based, operating within a web browser that provides the graphical user-interface.

Here we can see that user A's identity information 20 that is stored in memory of user A's computer has three identity attributes A1, A2 and A3. In this example A1 is an email address, A2 is a mobile phone number and A3 is a home phone number.

User A's address book 22 is also stored in the memory of user A's computer and has the identity information of users that are known to user A. User B is known to user A since user B's mobile number B2 is stored in the address book 22. This creates a relationship between users A and B shown schematically in FIG. 1 as 24.

User C is also known to user A who has stored user C's email address C1 and mobile phone number C2 creating a relationship shown schematically in FIG. 1 as 26.

The relationship 26 between user A and C is uni directional since user C does not have stored in their address book 28 any identity information of user A.

The relationship between users A and B is bidirectional since user A is known to user B as user A's email address A1 is stored in user B's address book 32. This forms the relationship between users B and A shown schematically in FIG. 1 as 30.

Again, the relationship between users B and C is bidirectional. User B has user C's office number C4 and home phone number C3 stored in their address 32 creating the relationship schematically shown as 40 in FIG. 1. User C has user B's email address B2 stored in their address book 28 creating the relationship schematically shown as 42 in FIG. 1.

Since user D's email address D1 is stored in user C's address book, the relationship schematically shown as 44 in FIG. 1 is created.

Note that there is no relationship defined between users A and D as neither user has any identity attributes of the other user stored in their address book 22.

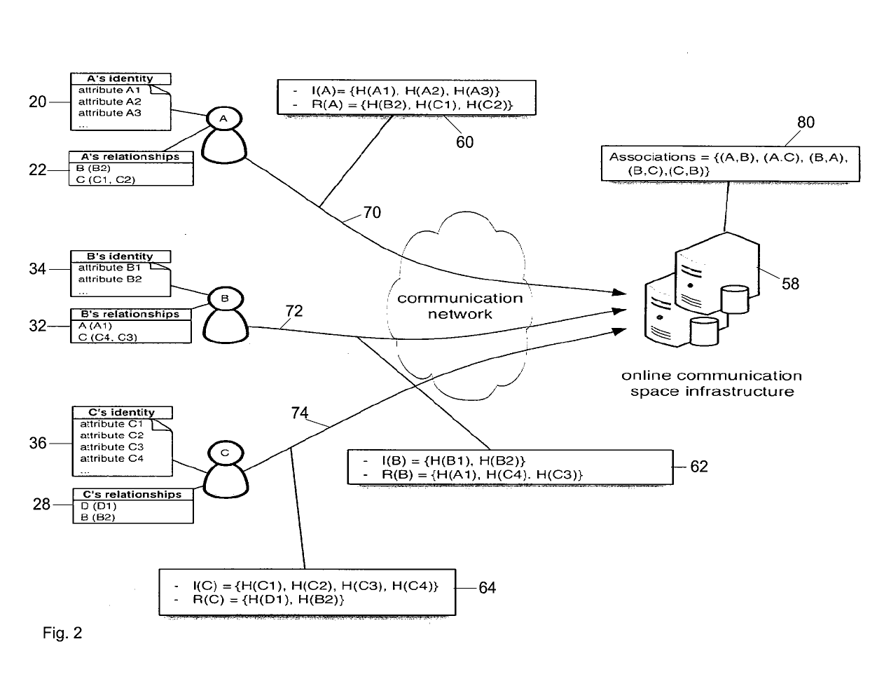

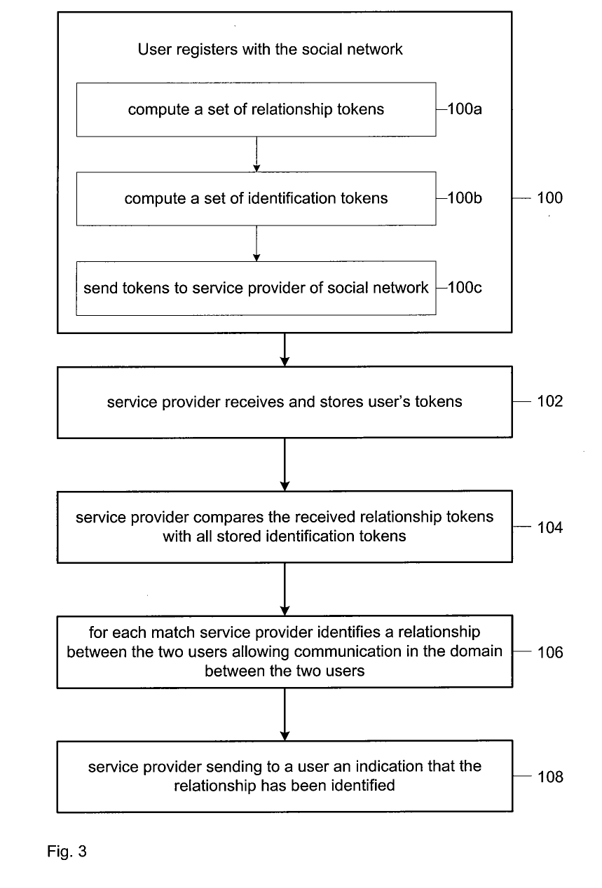

The service provider of the social network in this example is a set of servers shown schematically in FIG. 2 as 58. The service provider includes:
storage means, such as a large database that can store of the social network website, including content available on the website (e.g. photos), information on all registered users including identity and relationship tokens (discussed below) and indications of identified relationships.
a processor and software to support the social network including hosting the website and performing the steps to identify relationships; and
connection means, such as an interne connection to allow users to access the website of the social network.

A method of identifying these relationships in the online social network in a manner that maintains the privacy of each of the users will now be described with reference to FIGS. 2 and 3.

Referring first to user A, user A registers 100 with the online social network. In this example user A, using their device, accesses the website of the online social network. The website is hosted by one or more servers 58 that are the service providers of the social network. From the website or from a third party supplier, user A downloads a small application software that is then installed on their device.

As part of the registration process user A operates their device to compute an encrypted version of each identity attribute A1, A2 and A3 using the downloaded software 100a.

In this example the software computes a one-way encrypted version of each identity attribute in its relationship set. In this example, the secure hash function SHA-I is used to produce a set of identity tokens I(A)={H(A1), H(A2), H(A3)} representing user A's identity.

User A also operates their device to compute a one-way encrypted version of their address book 22 using the downloaded software 100b. Again using the secure hash function SHA-I each attribute in the address book is hashed to produce a set of relationship tokens R(A)={H(B2), H(C1), H(C2)} which represents all the possible users of the social network known to user A. They are possible users as user A is not yet aware whether or not the users in the contact list 22 are registered users of the social network. User A's token sets are schematically shown in FIG. 2 at 60. The computation of these token sets may be automatic in that the software can automatically detect user A's address book 22 as stored on their device and causes it to be sent to the server 58 (as described below).

In this example, user A's token sets are stored on their device. As part of the registration process, using the website, user A sends 70, 100c the two token sets 60 to the server 58. In this example the communication channel with the server 58 is insecure, but in other embodiments of this invention the communication channel may be secure.

The server 58 stores 102 these two token sets 60 in a related manner its relational database (or other suitable data structure) of all registered users.

User B and C also register with the social online network in the same way as user A which includes performing the same one-way encryptions steps. User B produces a set of identity tokens I(B)={H(B1), H(B2)} representing user B's identity. User B also produces a set of relationship tokens R(B)={H(A1), H(C4), H(C3)}. User B's token sets are schematically shown in FIG. 2 at 62. As part of the registration process user B sends 72 its token sets 62 to the server 58 where it is also stored.

User C computes an identity set of tokens I(C)={H(C1), H(C2), H(C3), H(C4)} representing user C's identity. User C also produces a set relationship of tokens R(C)={H(D1), H(B2)} representing all of user B's relationships. User C's token sets are schematically shown in FIG. 2 at 64. As part of the registration process user C sends 74 its token set 64 to the server 58 where it is also stored.

User D does not perform these encryption steps 100 as user D does not wish to become a registered user of this online social network.

As each new user registers with the social online network, the server 58 compares each of the received relationship tokens to the stored identity tokens of registered users. In this example, this is done as a bit comparison of tokens stored in the relational database or using a set of JOIN statements, linking users to stored tokens to relationship tokens to users again. This allows for a fast lookup on most Relational Database Engines. Alternatively, for large sets of users a search on a flat Identity Directory systems could be used. For each match with a distinct user, the server 58 identifies a relationship between the two users. The server 58 stores the identified relationship in the database as an association between those two users.

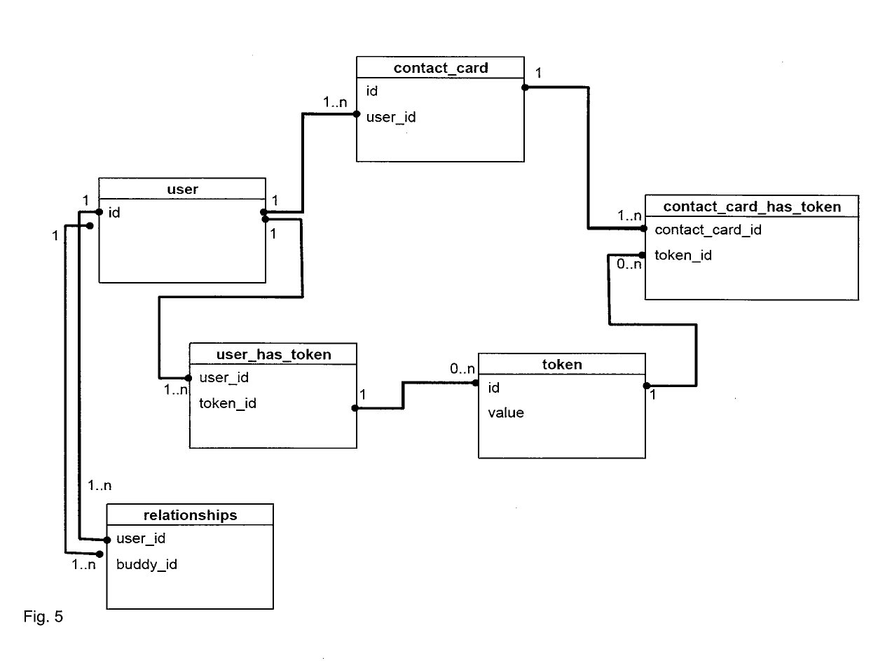

FIG. 5 shows the relational object model of this example where the tokens, relationships, users, and relationship are stored using a relational database, and this relational database is used to match tokens. The edge table is used to store relationship between users.

For example if user A is the first to register no relationships are identified by the server 58 as identity tokens corresponding to the attributes B2, C1 or C2 of user's relationship tokens are not found in the database.

User B is next to register. The server 58 matches user B's relationship token H(A1) to an identity token stored in the relational database. As a result the server 58 identifies a relationship between user B and A (B, A). An indication of this identified relationship (B, A) is also sent to user B by the server 58 (as described directly below) and an appropriate record is also stored in the database.

The server 58 now also checks 104 whether any previously registered users have a relationship token in the database that is the same as either of user B's identity tokens H(B1) and H(B2). The server 58 identifies 106 that user A's relationship token set does include H(B2) and accordingly identifies a relationship between user A and B (A, B). This makes the relationship between users A and B unidirectional. Server 58 creates an appropriate record in the database and sends 108 to user A an indication that the relationship (A, B) has been identified. For example, if user A is currently online in the social network, the webpage currently viewed by user A may be modified by information sent by the server 58 to show this, such as a pop up box. Alternatively, a message may be sent that can be retrieved by user A next time user A reads their emails or the next time user A is online.

User C is next to register. The server 58 identifies that user C's relationship token H(B2) is an identity token stored in the relational database. As a result server 58 identifies a relationship between user C and B (C, B). Server 58 also identifies that user C's relationship token H(D1) is not stored in the database and no new relationship is identifies with user D. The server 58 sends to user C an indication that the relationship (C, B) has been identified but does not send an indication that a relationship with user D has been found. In this way, user C receives an indication that user C now has a relationship with only a subset (B) of the possible users of the social network (B & D) listed in user C's address book 28.

The server 58 now also checks whether any previously registered users have a relationship token in the database that is the same as any of user C's identity tokens H(C1), H(C2), H(C3) and H(C4). The server 58 identifies that user A's relationship token set does includes H(C1) and H(C2) which uniquely matches to one user, namely user C. The server 58 identifies one relationship between user A and C (A, C). Since there is no relationship (C, A) this new relationship is unidirectional. The uni or bi directional relationship can be used by the communications domain to confer some attributes to the communications allowed between them. That is users involved in a unidirectional relationship may have different communication and information privileges to each other.

The server 58 identifies that user B's relationship token set does includes H(C4) and H(C3). The server stores an association between user B and C (B, C). Since the relationship (C, B) also exists this new relationship is bi-directional.

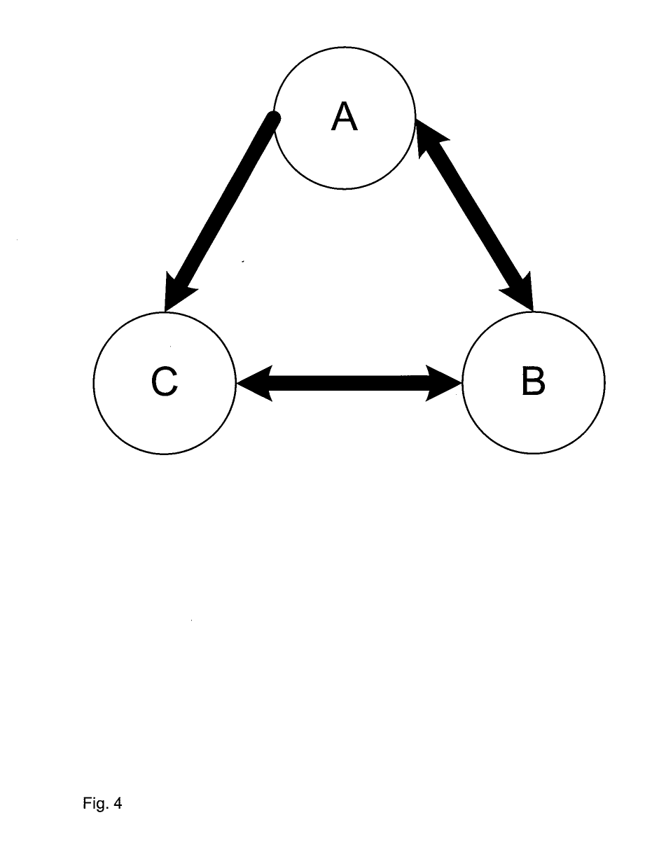

A summary of the relationships identified and stored on the server 58 is schematically shown in FIG. 2 at 80. This relationship set can also be represented as a graph shown in FIG. 4. The edge of each graph (defined by two users) can further be used in the social network to allow, deny or facilitate communication between the two users. In this example, the existence of the relationships (A, B) and (B,A) will allow users A and B to receive presence signals (online or not) about the each other, to view each others data made available to the domain (such as photos) and to initiate and participate chat sessions with each other.

In other communication domains, the edge (i.e. relationship) may allow user B to communicate with user A using synchronous or asynchronous messaging, such as email, instantaneous messaging, multimedia files transfers such as video, pictures and audio files and real-time streamed multi-media communication such as video or audio chat.

Over time, to maintain the relationships 80 so that they are synchronized with the data contained in the address books of the users A, B and C, a simple synchronization protocol is used to transmit only the variation of the address book to the servers. That is, the software on the user's device at a predetermined interval or based on the detection of an event, re-computes the identity and relationship token sets and compares it to the version of these token sets most recently computed and stored in the user's device. The differences are identified and only the differences are sent to the server 58.

A particular identity attribute may often be represented in different notation standards For example a phone number could be noted with the full country and area code or in a shorter version without the country code and still be correct. The following three numbers are different representations of user B's telephone number B2:

+33 1 42 23 11 54 (as stored by user B as an identity attribute)
0011 33 1 42 23 11 54 (as stored by user A as a relationship attribute)
01 42 23 11 54 (as stored by user A as a relationship attribute)

For these different representations of the same identity attribute, there is a chance that the server 58 will not correctly identity that they are in fact the same attribute and therefore fail to identify the relationships (A, B) and (C, B).

To address this, a transformation can be applied, specific to telephone numbers, where only the last k digits are selected by the software when encrypting an attribute. In this case where k=7, 2 23 11 54 is the number that is encrypted, in this example hashed.

When using this truncation technique the probability of collision increases. A collision can occur as phone number loose their globally unique semantic. For example, the following phone numbers: +1 4344-982-209 and +33 3 44 98 22 09 share the same suffix when k=7. As a result they would both produce the same tokens even though they represent different phone numbers. This may result in an incorrect relationship being identified by the server 58.

To address this, the criteria needed to create a relationship by the server could be made more strict. For example, a relationship may only be identified by the server where the relationship is bi-directional. Alternatively or in addition, having a relationship only identified if the two or more relationship tokens match two identity tokens of a user. That means a user needs to have a user's telephone number AND email address to identify a relationship.

Alternatively or in addition, the distance between two nodes in the graph (i.e. minimum number of edges) as an indicator of probability of collision. For example, if two user's have a relationship to a third user in common, the chance that they themselves have a relationship is much higher.

A privacy leak threat exists in the form of a brute-force attack is where the attacker tries every possible number to revert from the hash to the user's phone number. To mitigate this problem, a k in this example the phone number by using e.g. the last x digits, x being sufficiently large to minimise collision probability, but sufficiently small to maximize the user's privacy. For example, if user's A phone number is +1 421 510 889, one could choose to truncate it to 510 889 and hash that value instead.

It will be appreciated by persons skilled in the art that numerous variations and/or modifications may be made to the invention as shown in the specific embodiments without departing from the scope of the invention as broadly described.

The present embodiments are, therefore, to be considered in all respects as illustrative and not restrictive.

1. A computer implemented method of identifying relationships between users in a communications domain comprising:
(a) storing identification tokens, wherein each identification token is one-way encrypted identification information associated with a domain user;
(b) receiving relationship tokens from a first user, wherein each relationship token is one-way encrypted identification information associated with a possible domain user;
(c) comparing the relationship tokens to the identification tokens to identify any matches; and
(d) for each match to a unique domain user, identifying a relationship between the first user and the domain user associated with the matched identification token, wherein the relationship allows communication in the domain between the first user and the domain user associated with the matched identification token.

2. A method according to claim 1, wherein the one-way encrypted identification information of an identification token corresponds to one or more identity attributes of the associated domain user.

3. A method according to claim 1, wherein the one-way encrypted identification information of a relationship token corresponds to one or more identity attributes of a possible domain user.

4. A method according to claim 1, wherein an identity attribute is one of telephone number, email address, facsimile number, street address, and user name in a different communications domain.

5. A method according to claim 1, wherein an identity attribute is a predetermined number of suffix characters of an identity attribute.

6. A method according to claim 1, wherein the identification information associated with possible domain users is identification information known to the first user.

7. A method according to claim 1, wherein the one-way encrypted identification information is a secure hash.

8. A method according to claim 1, wherein the method further comprises the step of analysing analyzing previously identified relationships of the first user and/or the domain user associated with the matched identification token and only identifying a match in step (c) if the previously identified relationships are indicative that the two users know each other.

9. A method according to claim 1, wherein the method further comprises only identifying a match in step (c) if at least two identification tokens associated with the domain user are matched to the relationship tokens of the first user.

10. A method according to claim 1, wherein the allowed communications between the first user and the domain user associated with the matched identification token in the communications domain includes one or more of:
online presence awareness communications,
access to content stored in the communications domain by the first user, content transfers, and
real-time message interaction.

11. Software, being computer readable instructions stored on computer readable media that when executed by a computer causes the computer to perform the method according to claim 1.

12. A computer system for identifying relationships between users in a communications domain comprising:
a storage device to store identification tokens, wherein each identification token is one-way encrypted identification information associated with a domain user;
an input means to receive relationship tokens from a first user, wherein each relationship token is one-way encrypted identification information associated with a possible domain user; and
a processor to compare the relationship tokens to the identification tokens to 5 identify any matches, and, for each match to a unique domain user, identify a relationship between the first user and the domain user associated with the matched identification token, wherein the relationship allows communication in the domain between the first user and the domain user associated with the matched identification token and to store the identified relationship in the storage device.

13. A method for identifying relationships between a first user and other users in a communications domain, comprising:
(a) computing a set of relationship tokens, wherein each token in the set is one way encrypted identification information of a possible user of the domain known to the first user;
(b) sending the set of relationship tokens to a service provider of the domain; and
(c) receiving an indication that relationships have been identified between the first user and a subset of the possible users, where the subset of possible users are registered users of the domain and the relationships allow communication in the domain between the first user and the subset of possible users.

14. The method according to claim 13, wherein the one-way encrypted identification information of a relationship token corresponds to one or more identity attributes of a possible domain user.

15. The method according to claim 13, wherein the identity attributes are read from an electronic address book of the first user.

16. The method according to claim 13, wherein the method further comprises the steps of:
computing identity tokens of the first user, wherein each identification token is one-way encrypted identification information associated with the first user;
sending the identity tokens to the service provider of the domain; and
receiving an indication that a relationship has been between identified between the first user and other domain users based on the identity tokens, wherein the identified relationship allows communication in the domain between the first user and the other domain users.

17. Software, being computer readable instructions stored on computer readable media that when executed by a computer causes the computer the perform the method according to claim 13.

18. A communications enabled device to identify relationships between a first user and other users in a communications domain, comprising:
processing means to computing a set of relationship tokens, wherein each token in the set is one-way encrypted identification information of a possible user of the domain known to the first user;
output means to send the set of relationship tokens to a service provider of the domain; and
input means to receive an indication that relationships have been identified between the first user and a subset of the possible users, where the subset of possible users are registered users of the domain and the relationships allow communication in the domain between the first user and the subset of possible users.
